(19) United States
(12) Patent Application Publication
(10) Pub. No.: US 2025/0370444 A1
(43) Pub. Date: Dec. 4, 2025

(54) BOT SOFTWARE FOR MACHINE CONTROL

(71) Applicant: Klingelnberg GmbH, Hückeswagen (DE)

(72) Inventor: Daniel Meuris, Witten (DE)

(21) Appl. No.: 19/227,023

(22) Filed: Jun. 3, 2025

(30) Foreign Application Priority Data
Jun. 4, 2024 (DE) 10 2024 115 491.8

(51) Int. Cl. G05B 19/423; G05B 19/4155

(52) U.S. Cl. CPC G05B 19/423; G05B 19/4155

(57) ABSTRACT

A machine for machining and/or measuring gearing, having two or more numerically controlled machine axes for carrying out machining movements and/or measuring movements, having a machine controller, wherein the machine controller has a control software, wherein the control software is set up for executing machine functions, such as executing program sequences for controlling the numerically controlled machine axes, the output of service reports or the like. The machine controller has a user interface set up for interaction with a machine operator, wherein for at least one of the machine functions it is predetermined by the control software that the execution of this machine function requires at least one manual input by a machine operator at the user interface. A bot software is assigned to the control software in order to replace the at least one manual input and to execute the machine function independently of a machine operator.

### CROSS-REFERENCE TO RELATED APPLICATIONS

This application claims the benefit of German patent application 10 2024 115 491.8, filed on 4 Jun. 2024, the disclosure of which is incorporated herein by reference in its entirety.

### TECHNICAL FIELD

The present disclosure relates to a machine for machining and/or measuring gears having two or more numerically controlled machine axes for carrying out machining movements and/or measuring movements, having a machine controller, wherein the machine controller has a control software, wherein the control software is set up for executing a plurality of machine functions, such as executing program sequences for controlling the numerically controlled machine axes, the output of service reports or the like, wherein the machine controller has a user interface, wherein the user interface is set up for interaction with a machine operator, wherein for at least one of the machine functions it is predetermined by the control software that the execution of this machine function requires at least one manual input by a machine operator at the user interface. The disclosure also relates to a method for controlling such a machine.

### BACKGROUND

The machine parks of many companies contain machines for machining and/or measuring gears whose machine controls are no longer state of the art, but which continue to achieve excellent measuring and machining results mechanically, i.e. at the actual process level.

Modernizing such machines to the latest control systems is often impossible or uneconomical. As a result, machines are taken out of service due to a lack of network or automation functions, for example, even though these machines achieve the required measuring or processing results in the specified quality.

Against this background, the present disclosure is based on the technical problem of providing an improved machine for machining and/or measuring gears and an improved method for controlling such a machine, which in particular enables efficient retrofitting of network and/or automation functions.

### SUMMARY

The technical problem described above is solved in each case with the features of the independent claims. Further embodiments of the disclosure result from the dependent claims and the following description.

According to a first aspect, the disclosure relates to a machine for machining and/or measuring gears, having two or more numerically controlled machine axes for executing machining movements and/or measuring movements, having a machine controller, wherein the machine controller has a control software, wherein the control software is set up to execute a plurality of machine functions, such as executing program sequences for controlling the numerically controlled machine axes, the output of service reports or the like, wherein the machine controller has a user interface, wherein the user interface is set up for interaction with a machine operator, wherein for at least one of the machine functions it is specified by the control software that the execution of this machine function requires at least one manual input by a machine operator at the user interface. The machine is characterized in that bot software is assigned to the control software in order to replace the at least one manual input and to execute the machine function independently of a machine operator.

In this case, the bot software acts as a “virtual” machine operator, wherein input values are transferred to the control software by means of the bot software that are the same as the input values that would be generated as a result of manual input by a machine operator or that would result from manual input by a machine operator.

For example, to output a service report, the control software may require a machine operator to make several consecutive entries at the user interface in order to navigate through the specified software menu and finally trigger the selection and output of the service report.

The bot software can be used to simplify this procedure, for example by automatically issuing and saving service reports at certain times or after the production of certain quantities, wherein the bot software replaces the user input for executing the service report. In this way, automation can take place without having to intervene in the existing control software.

Alternatively, the bot software can be used, for example, to create shortcuts that trigger certain machine functions that exist deep in the sub-levels of the menu structure and require a large number of user inputs with a single user input to save time-consuming navigation through the menu structure of the control software.

The bot software therefore enables automation or partial automation of existing machine functions. The bot software does not add any new machine functions to the machine in the sense of new processing or measuring functions.

The bot software can be installed on the machine controller and the control software can remain unchanged. The bot software can therefore be a retrofit solution, in particular, in order to partially or fully automate machine functions that can be executed using existing control software, which would necessarily require manual user input without the bot software.

The terms “user input”, “operator input” and “manual input” are used synonymously in this text.

It may be provided that the control software does not have a network function, such as remote control, remote maintenance, remote diagnostics, an intranet connection, an internet connection or the like, and that the bot software has such a network function. The bot software can therefore be used to network the machine with a server and/or with other machines. For example, service reports that were originally triggered manually and stored locally can be created remotely using the bot software and sent via the network function, e.g. to a server. It is understood that appropriate hardware interfaces for network connection, such as a LAN or WLAN module, may need to be available or retrofitted for this purpose.

The bot software can be trained on the machine controller, wherein in particular a sequence of manual operator inputs can be recorded, stored and repeated as an automated program sequence.

In this way, certain input values that are the result of manual operator input, such as the navigation of menu structures of the control software, can be saved and transferred chronologically to the control software in the automated program sequence by means of the bot software in order to suggest manual operator input to the control software, so that the bot software represents a virtual machine operator.

The bot software can be set up to transmit input values to an existing input interface, such as a keyboard controller, a mouse controller, a touchscreen controller or similar. The bot software therefore transfers data to the input interface that is identical to the data resulting from manual inputs.

According to a second aspect, the disclosure relates to a method for controlling a machine according to the disclosure, comprising the method steps of: executing a machine function of a machine, wherein it is predetermined for this machine function by the control software that the execution of this machine function requires at least one manual input by a machine operator at the user interface; replacing the at least one manual input by means of the bot software, wherein the bot software transmits to the control software in particular at least one input value which is equal to that at least one input value which would result from a manual input.

The method may comprise performing remote control and/or remote maintenance and/or remote diagnostics of the machine by means of the bot software.

The method may involve training the bot software on the machine controller by recording a sequence of manual operator inputs, storing them and repeating them as an automated program sequence.

### BRIEF DESCRIPTION OF THE DRAWINGS

The disclosure is described in more detail below with reference to a drawing illustrating exemplary embodiments. The figures show schematically in each case:

FIG. 1 shows a machine according to the disclosure for measuring gears;

FIG. 2 shows a machine according to the disclosure for machining gears; and

FIG. 3 shows method steps of a method according to the disclosure.

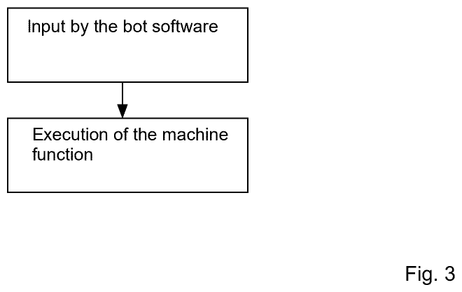

### DETAILED DESCRIPTION OF THE DRAWINGS

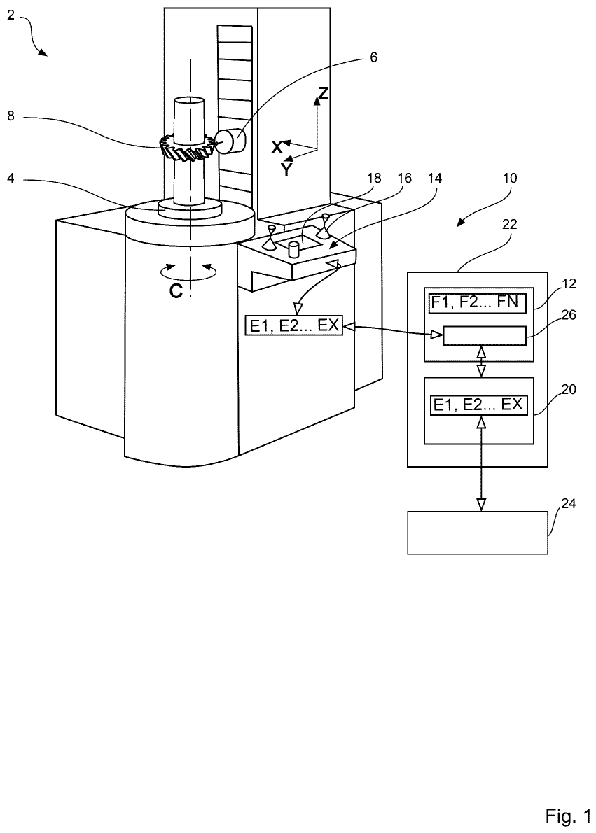

FIG. 1 shows a machine 2 for measuring gears. The machine 2 is a coordinate measuring machine.

The machine 2 has 3 CNC-controlled linear axes, which are designated X, Y and Z in the present case, and which enable relative degrees of freedom of movement of a measuring probe 6 relative to a gearing 8 to be measured. Furthermore, the coordinate measuring machine 2 has a rotary table 4, which enables a rotational degree of freedom according to the rotational axis C. The reference signs X, Y and Z denote coordinate directions and also stand for CNC-controlled linear axes for moving the measuring probe 6.

The machine axes for executing relative measuring movements, which are referred to here as X, Y, Z and C, are therefore numerically controlled machine axes for executing measuring movements.

The coordinate measuring machine 2 has a machine controller 10. The machine controller 10 has control software 12. The control software 12 is set up to execute a plurality of machine functions F1, F2 . . . FN. These machine functions can be, for example, the execution of program sequences for controlling the numerically controlled machine axes, the output of service reports or the like.

The machine controller 10 has a user interface 14. The user interface 14 has input elements 16 and a display 18 for displaying information to a machine operator. The input elements 16 can include, for example, joysticks, a keyboard and/or a mouse or the like, i.e. all common input elements that are required for navigating through software menus or for entering data in input dialogs. The user interface 14 is therefore set up for interaction with a machine operator, or enables a machine operator to set up and execute measurement processes, for example.

For at least one of the machine functions F1, F2 . . . FN, the control software 12 specifies that the execution of this machine function requires at least one manual input by a machine operator at the user interface 14. In other words, the control software 12 requires one or more inputs at the user interface in an input dialog or due to the menu structure of the software menu, which are transmitted as input values E1, E2 . . . EX from the user interface 14 to the control software 12 until the relevant machine function F1, F2 . . . FN is executed by the machine 2.

In order to replace this at least one manual input and to execute the relevant machine function F1, F2 . . . FN independently of a machine operator, a bot software 20 is assigned to the control software 12.

The bot software 20 is set up to automatically enter into the control software 12 those input values E1, E2 . . . EX that are equal to the input values E1, E2 . . . EX that would result from manual input. Manual input by a user can therefore be omitted.

For example, it may be provided that the machine function which, according to the control software, requires an input from the machine operator in the area of the user interface 14 is the output of a service report, which is designated, for example, as F2.

According to the control software 12, it may be necessary to successively pass through several menu levels of a software menu of the control software 12 by selecting and confirming displayed buttons or selection options until the output of the relevant service report is started. Therefore, for example, two input values E1 and E2 are successively transferred from the user interface 14 to the control software 12 by selection and confirmation by a machine operator.

The bot software 20 can run through the menu levels automatically by transferring the corresponding input value E1, E2 to the control software 12 for each query or each required menu selection until the confirmation of the service report output is reached to confirm each individual query or menu selection. It is understood that, depending on the menu structure of the software menu, a large number of entries must be made, which can be replaced by the bot software 20.

Such navigation of menu levels of the software menu 12 can be carried out, for example, by training the bot software 20 on the machine controller 10, in which a sequence of manual operator inputs is recorded, stored and executed as an automated program sequence. For example, the bot software 20 can provide a short command that replaces all the inputs required to execute the output of the service report with a single selection.

The described output of the service report is just a simple example of the possibilities provided by the aforementioned bot software 20. This means that even complex measurement processes can be simplified and automated.

The advantage of using the bot software 20 is that the automation or simplification of the accessibility of certain machine functions takes place without any intervention in the control software 12 itself, so that the control software 12 can remain unchanged. The bot software 20 is installed on the machine controller 10 in the present case. The control software 12 and the bot software 20 are shown here only schematically for illustrative purposes externally to the measuring machine 2. It is understood that the control software 12 and the bot software 20 are installed on a computer 22 integrated in the measuring machine 2.

A further improvement of the measuring machine 2 can be achieved by using the bot software 20 by providing network functions by means of the bot software 20. Thus, the control software 12 does not have any network functions, such as remote control, remote maintenance, remote diagnosis, an intranet connection, an internet connection or the like, while the bot software 20 enables one or more of the aforementioned network functions.

For example, it may be provided that the aforementioned service report is triggered or executed externally via a server 24 using the bot software 20 and is also transmitted from the machine 2 to the external server 24 using the network function. The bot software 20 therefore enables subsequent networking of the machine 2 without having to change the control software 12.

The bot software 20 is set up to transmit input values E1, E2 . . . EX to an already existing input interface 26, such as a keyboard controller, a mouse controller, a touchscreen controller or the like. The input values E1, E2 . . . EX of the bot software 20 are indistinguishable for the input interface 26 from those input values E1, E2 . . . EX that are generated by manual input at the user interface 14. The bot software 20 is therefore a virtual user that generates keyboard input for the keyboard controller, for example.

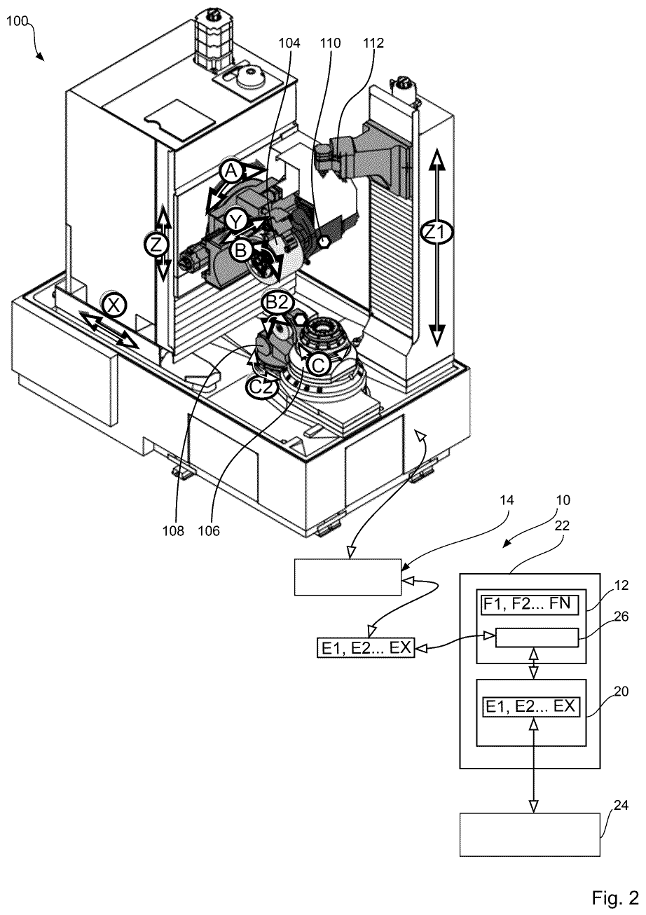

The principle of using bot software 20 described above can also be applied to a machine tool for the machining of gears. FIG. 2 shows an example of a machine tool 102 for gear grinding according to the disclosure.

In order to avoid repetition, only the differences to the aforementioned exemplary embodiment are discussed below, with the same reference signs being assigned to the same features.

The gear grinding machine 102 has a tool spindle 104 for holding and rotationally driving a grinding tool. The gear grinding machine 102 has a workpiece spindle 106 for holding and rotationally driving a toothed component to be ground. The gear grinding machine has a dressing device 108 for dressing grinding tools.

The gear grinding machine 102 has numerically controlled machine axes X, Y, Z, A, B, C, C2, B2 for executing translational and rotational relative movements in order to provide the required machining kinematics during gear cutting or dressing. Furthermore, the gear grinding machine 102 has an axis Z1 with a displaceable quill 112 for clamping shafts or mandrels.

The gear grinding machine 102 can also be remotely controlled using the bot software or diagnostic data, such as service reports or the like, can be queried and transmitted via external network access to the machine.

According to the disclosure, therefore, a method for controlling a machine according to one of the preceding claims is provided, comprising the method steps of:

Executing a machine function of a machine 2, 102, wherein for this machine function it is predetermined by the control software 12 that the execution of this machine function requires at least one manual input by a machine operator at the user interface 14; replacing the manual input by means of the bot software 20, wherein the bot software 20 passes an input value to the control software 12 which is equal to that input value which would result from a manual input. In other words, instead of a physical input by an operator, a virtual input is made by the bot software 20 to perform the machine function.

1. A machine for machining and/or measuring gears, the machine comprising:
having two or more numerically controlled machine axes for carrying out machining movements and/or measuring movements,
having a machine controller,
wherein the machine controller has control software,
wherein the control software is set up for executing a plurality of machine functions, such as executing program sequences for controlling the numerically controlled machine axes, or output of service reports,
wherein the machine controller has a user interface,
wherein the user interface is set up for interaction with a machine operator,
wherein for at least one of the machine functions it is predetermined by the control software that the execution of this machine function requires at least one manual input by a machine operator at the user interface,
wherein
a bot software is assigned to the control software in order to replace the at least one manual input and to execute the machine function independently of a machine operator.

2. The machine according to claim 1,
wherein
the bot software is installed on the machine controller and the control software remains unchanged.

3. The machine according to claim 1,
wherein
the control software does not have a network function, such as remote control, remote maintenance, remote diagnosis, an intranet connection, or an internet connection, and in that the bot software has a network function.

4. The machine according to claim 1,
wherein the bot software is configured to be trained on the machine controller, wherein a sequence of manual operator inputs is configured to be recorded, stored, and repeated as an automated program sequence.

5. The machine according to claim 1,
wherein the bot software is set up to transmit input values to an existing input interface, such as a keyboard controller, a mouse controller, or a touchscreen controller.

6. A method for controlling the machine according to claim 1, the method including the following steps:
executing a machine function of a machine, wherein it is predetermined for this machine function by the control software that the execution of this machine function requires at least one manual input by a machine operator at the user interface; and
replacing the at least one manual input by means of the bot software, wherein the bot software transmits to the control software at least one input value which is equal to that at least one input value which would result from the at least one manual input.

7. The method according to claim 6,
whereby performing remote control and/or remote maintenance and/or remote diagnosis of the machine wherein the control software does not have a network function, such as remote control, remote maintenance, remote diagnosis, an intranet connection, or an internet connection, and in that the bot software has a network function using the bot software.

8. The method according to claim 5,
further including the step of training the bot software on the machine controller by recording a sequence of manual operator inputs, storing them and repeating them as an automated program sequence.
